(19) United States
(12) Patent Application Publication
(10) Pub. No.: US 2008/0309545 A1
(43) Pub. Date: Dec. 18, 2008

(54) Speed Measuring Device Including Fresnel Zone Plate Lens Antenna

(75) Inventors: Kazem F. Sabet, Ann Arbor, MI (US); Kamal Sarabandi, Ann Arbor, MI (US); Linda P.B. Katehi, Zionsville, IN (US); Jiyoun Munn, Ann Arbor, MI (US)

Correspondence Address: MILLER IP GROUP, PLC;EMAG TECHNOLOGIES, INC., 42690 WOODWARD AVE., SUITE 200, BLOOMFIELD HILLS, MI, 48304, US

(73) Assignee: EMAG Technologies, Inc., Ann Arbor, MI (US)

(21) Appl. No.: 11/764,070

(22) Filed: Jun. 15, 2007

(51) Int. Cl. G01S 13/02

(52) U.S. Cl. 342/104

(57) ABSTRACT

A speed measuring device that employs a Fresnel zone plate lens antenna. The Fresnel lens antenna is mounted to one end of a low profile collection housing, typically cylindrical in configuration. An opposite end of the collection housing includes a back plate having an opening. A transceiver unit is mounted to the outside surface of the back plate so that a transmitter and a detector within the transceiver are in communication with the opening. A signal is transmitted from the transceiver unit through the opening, and is directed by the lens antenna. A reflected signal is received and focused by the lens antenna, and collected by the housing to be directed through the opening to the transceiver.

### BACKGROUND OF THE INVENTION

1. Field of the Invention

This invention relates generally to a speed measuring device and, more particularly, to a speed measuring device including a low profile collection housing and a Fresnel zone plate lens antenna mounted thereto that focuses a transmit beam and a receive beam.

2. Discussion of the Related Art

Speed measuring devices have many applications in the art, such as vehicle speed detection. One type of speed measuring device uses RF signals and the Doppler effect to determine the speed of an object. A speed measuring device that uses the Doppler effect includes a transceiver that transmits a narrow band RF beam towards a target, and receives a reflected beam from the target. The reflected beam will be shifted in frequency from the transmitted beam relative to the speed of the target. Known speed measuring devices of this type typically employ an antenna horn that directs and focuses the transmitted beam from the transceiver, collects the reflected beam and focuses the reflected beam onto a detector in the transceiver. However, horn antennas typically have a long profile that is determined based on the frequency being transmitted, which adds significant size to the device. Further, horn antennas have a small aperture size, which reduces the system gain.

### SUMMARY OF THE INVENTION

In accordance with the teachings of the present invention, a speed measuring device is disclosed that employs a Fresnel zone plate lens antenna. The Fresnel lens antenna is mounted to one end of a low profile collection housing, typically cylindrical in configuration. An opposite end of the collection housing includes a back plate having an opening. A transceiver unit is mounted to the outside surface of the back plate so that a transmitter and a detector within the transceiver are in communication with the opening. A signal is transmitted from the transceiver unit through the opening, and is directed by the lens antenna. A reflected signal is received and focused by the lens antenna, and collected by the housing to be directed through the opening to the transceiver. The transceiver uses the Doppler effect to detect a difference in frequency between the transmitted beam and the reflected beam to determine the speed of a target from which the transmitted beam is reflected.

Additional features of the present invention will become apparent from the following description and appended claims, taken in conjunction with the accompanying drawings.

### BRIEF DESCRIPTION OF THE DRAWINGS

FIG. 1 is a front view of a speed measuring device employing a Fresnel zone plate lens antenna, according to an embodiment of the present invention;

FIG. 2 is a back view of the speed measuring device shown in FIG. 1;

FIG. 3 is an exploded rear perspective view of the speed measuring device shown in FIG. 1;

FIG. 4 is an exploded front perspective view of the speed measuring device shown in FIG. 1 without the Fresnel zone plate lens antenna;

FIG. 5 is a front view of a transceiver that is part of the speed measuring device of the invention;

FIG. 6 is a plan view of the front of a Fresnel zone plate lens antenna showing the radius of the zones relative to the lens focal point; and

FIG. 7 is a schematic diagram of the speed measuring device of the invention.

### DETAILED DESCRIPTION OF THE EMBODIMENTS

The following discussion of the embodiments of the invention directed to a speed measuring device employing a Fresnel zone plate lens antenna is merely exemplary in nature, and is in no way intended to limit the invention or its applications or uses.

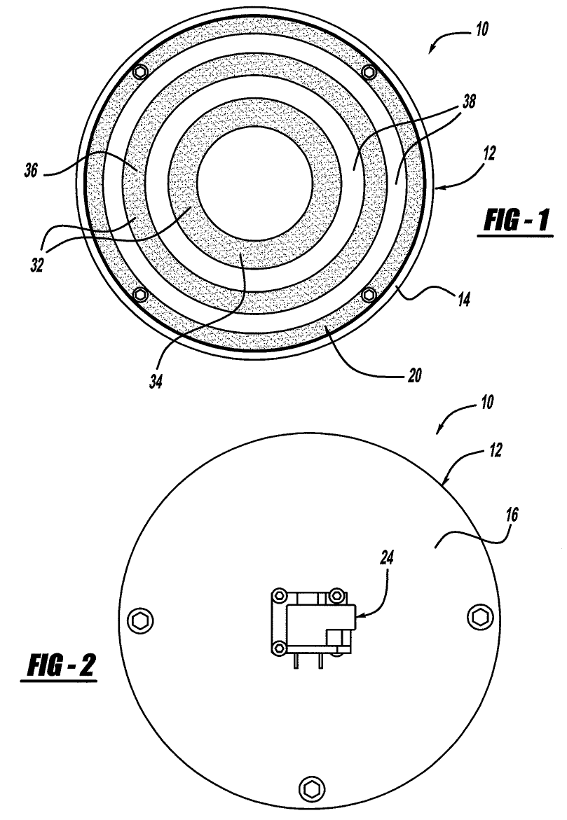

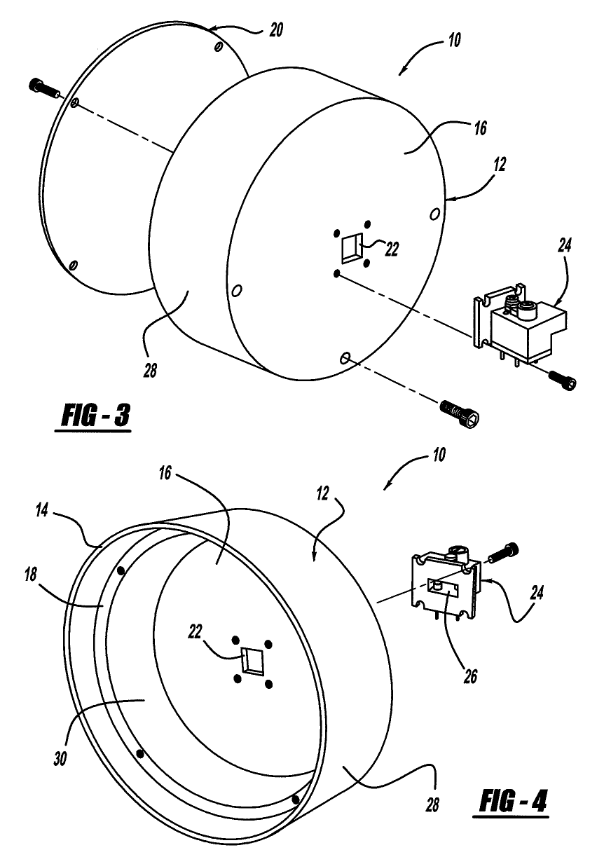

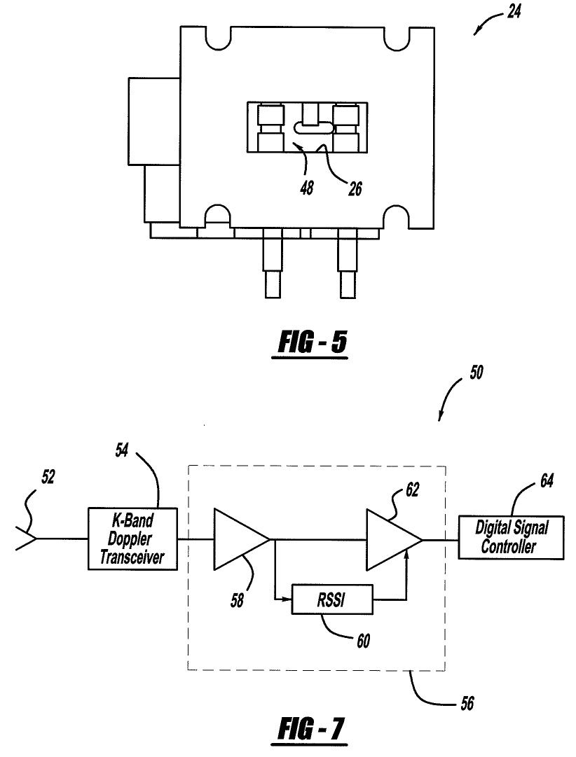

FIG. 1 is a front view, FIG. 2 is a rear view, FIG. 3 is an exploded rear perspective view and FIG. 4 is an exploded front perspective view of a speed measuring device 10, according to an embodiment of the present invention. The device 10 includes a cylindrical collection housing 12 having a forward facing edge 14, a side plate 28 and a back plate 16, where a cavity 30 is defined within the housing 12. In this non-limiting embodiment, the collection housing is made of aluminum, and is operable to reflect RF waves. Alternately, the collection housing 12 can be made of a low weight and durable material, such as a suitable plastic, and an inside surface or an outside surface of the collection housing 12 can be coated with a metal layer to provide the wave reflection. The diameter of the collection housing 12 determines the gain of the device 10. In one non-limiting embodiment, the collection housing 12 has a diameter in the 4-5 inch range and a height of about 2 inches.

A planar Fresnel zone plate lens antenna 20 is mounted, here by bolts, to a shoulder 18 provided in the collection housing 12. FIG. 4 shows the device 10 without the Fresnel lens antenna 20 mounted thereto so as to show the interior cavity 30 of the collection housing 12. The back plate 16 includes a square opening 22 through which the transmitted and reflected RF beams propagate. A transceiver module 24 is mounted, here by bolts, to the back plate 16 so that an opening 26 in the transceiver module 24 is in communication with the opening 22. FIG. 5 is a front view of the transceiver module 24 separated from the device 10. In one non-limiting embodiment, the speed measuring device 10 operates in the K band, i.e., 12-93 GHz, where the Kₐ band is in the 18-40 GHz range and is mainly used for radar and general communications, and the Kᵤ band is the 12-18 GHz range and is mainly used for satellite communications.

The Fresnel lens antenna 20 is made of a circular planar dielectric material and includes a plurality of spaced apart metallized rings 32 separated by dielectric rings 38. In this non-limiting embodiment, the lens antenna 20 includes two metallized rings 34 and 36, where the interior ring 34 is wider than the exterior ring 36, but where the area of the rings 34 and 36 is about the same. The width of the rings 32 determines the focal length of the lens antenna 20. In one embodiment, the material of the lens antenna 20 is a low-loss dielectric material, such as polystyrene, and the rings 32 are deposited thereon by a suitable deposition process. In one non-limiting embodiment, the lens antenna 20 has a dielectric constant of εᵣ=4.7+0.03j. The thickness of the lens antenna 20 is determined by choosing low reflection coefficients from wave transmitting simulations through multi-layered dielectrics. In one non-limiting embodiment, the Fresnel lens antenna 20 has approximately a 22 dB gain, a diameter of about 4.0 inches and a thickness of about one-eighth of an inch.

The operation of a Fresnel lens is well understood to those in the art. An RF beam propagates through the dielectric rings 38 between the metallized rings 32, and is prevented from propagating through the metallized rings 32 of the lens antenna 20. Therefore, a Fresnel lens can be designed so that the parts of the beam that are at one phase are blocked, and the parts of the beam that are in phase with each other pass through the lens antenna 20 and can be combined.

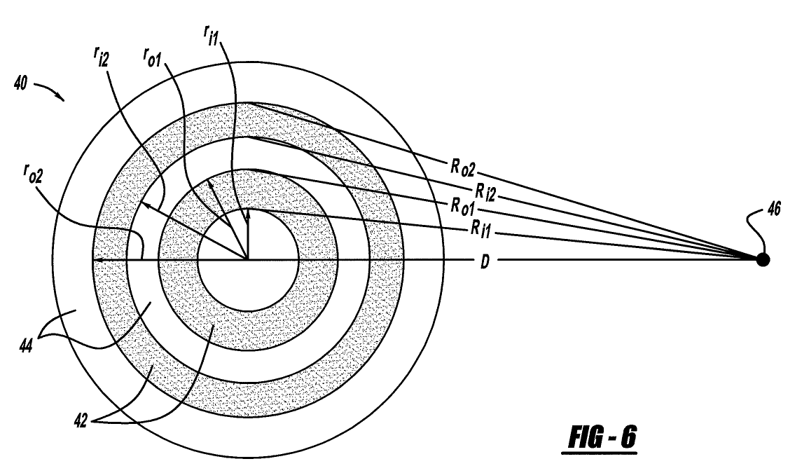

For a phase-reversing zone plate, the successive radius of the zones (rings) are chosen so that the distance from a selected focal point, such as the opening 22, on the central axis increases by one-half the wavelength of the center frequency of the beam going from the inner radius to the outer radius of any ring 32. This is illustrated in FIG. 6 where a Fresnel lens 40 is shown including opaque rings 42 separated by dielectric rings 44. The distance between the focal point 46 and the center of the lens 40 is shown as distance D, the radius of the rings 42 are shown as radius R from the focal point 46 and the wavelength of the RF signal is A. As the RF beam propagates through the lens antenna 20 it is defracted at the edges of the rings 32, and focuses at the focal point at the opening 22.

The following equations are used to define the size of the zones for phase calculation purposes.

Rᵢ₁=D+0.5λ (1)

rᵢ₁=\sqrt{Rᵢ₁²−D²} (2)

Rₒ₁=D+λ (3)

rₒ₁=\sqrt{Rₒ₁²−D²} (4)

Rᵢ₂=D+1.5λ (5)

rᵢ₂=\sqrt{Rᵢ₂²−D²} (6)

Rₒ₂=D+2λ (7)

rₒ₂=\sqrt{Rₒ₂²−D²} (8)

In this non-limiting embodiment, the transceiver module 24 includes a Gunn diode transceiver 48. The transceiver module 24 is a commercially available integrated module with a Gunn diode mounted in a cavity for the transmitter and one or two Shottkey barrier diode in the receiver. In one non-limiting embodiment, the transceiver module 24 is one of several modules available from MDT depending on the transmit frequency. An IF output is generated whose frequency is proportional to the targets velocity. With the two-mixer design, the direction-of-motion is obtained as a phase difference between the two intermediate frequency (IF) outlets. The Doppler sensor within the transceiver module 24 has about 5 mWs of output power and supports dual IFs, which are capable of detecting the direction of the moving object.

FIG. 7 is a schematic block diagram of a speed measuring system 50 including an antenna 52 representing the Fresnel lens antenna 20, and a K-band Doppler transceiver 54, representing the transceiver module 24. The system 50 includes an IF processing circuit 56 including an IF amplifier 58, a receive signal strength indicator (RSSI) processor 60 and an attenuator/amplifier 62. The RSSI processor 60 measures the amplified IF signal. Based on the measured RSSI value and a predetermined threshold, the attenuator/amplifier 62 operates as either an attenuator to reduce the strength of the signal or as an amplifier to increase the strength of the signal so that the signal is substantially constant for signal processing. The strength of the reflected signal will depend on how close the target is to the system 50. The conditioned signal from the attenuator/amplifier 62 is passed to a digital controller 64, such as a DSPIC 30. The digital controller 64 includes an analog-to-digital converter and a digital signal processor functioning with a 16-bit microcontroller architecture. The controller 64 converts the received analog signal to a digital signal and converts the signal from the time domain to the frequency domain using a fast Fourier transform (FFT) with implemented software. The power spectral density of the processed signal is then analyzed for frequency content, which indicates the Doppler shifted frequency of the target.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A speed measuring device comprising:
a collection housing including an open end and a back plate, said back plate including an opening;
a transceiver module mounted to the back plate and being in communication with the opening; and
a Fresnel zone plate lens antenna mounted proximate to the open end of the collection housing, wherein the transceiver module transmits an RF signal into the collection housing that is focused by the Fresnel lens, and wherein the Fresnel lens receives a reflected RF signal that is collected by the collection housing and directed through the opening to the transceiver module.

2. The device according to claim 1 wherein the transceiver module includes a transmitter having a Gunn diode.

3. The device according to claim 1 wherein the collection housing is cylindrical and the Fresnel lens antenna is cylindrical.

4. The device according to claim 1 wherein the Fresnel lens antenna includes at least two concentric metallized rings that block the RF signal separated by dielectric rings that pass the RF signal, wherein the metallized rings increase in diameter from an interior ring to an exterior ring.

5. The device according to claim 1 wherein the collection housing has a diameter between 4 and 5 inches.

6. The device according to claim 1 wherein the collection housing has a height of about two inches.

7. The device according to claim 1 wherein the Fresnel zone plate lens antenna has a thickness of about one-eighth of an inch.

8. The device according to claim 1 wherein the device operates in a K band.

9. The device according to claim 1 wherein the collection housing is made of metal.

10. The device according to claim 1 wherein the Fresnel lens antenna is made of a low-loss dielectric material having a dielectric constant of about 4.7.

11. A speed measuring device comprising:
a cylindrical collection housing including an open end and a back plate, said back plate including an opening, said collection housing having a diameter between 4 and 5 inches and a height of about two inches;
a transceiver module mounted to the back plate and being in communication with the opening, said transceiver module using the Doppler effect to detect the speed of a target; and
a Fresnel zone plate lens antenna mounted proximate to the open end of the collection housing, said lens antenna including a plurality of concentric metallized rings separated by dielectric rings, wherein the transceiver module transmits an RF signal into the collection housing that is focused by the Fresnel lens, and wherein the Fresnel lens receives a reflected RF signal that is collected by the collection housing and directed through the opening to the transceiver module.

12. The device according to claim 11 wherein the transceiver module includes a transmitter having a Gunn diode.

13. The device according to claim 11 wherein the Fresnel lens antenna includes at least two concentric metallized rings that block the RF signal separated by dielectric rings that pass the RF signal, wherein the metallized rings increase in diameter from an interior ring to an exterior ring.

14. The device according to claim 11 wherein the Fresnel zone plate lens antenna has a thickness of about one-eighth of an inch.

15. The device according to claim 11 wherein the device operates in a K band.

16. The device according to claim 11 wherein the collection housing is made of metal.

17. The device according to claim 11 wherein the Fresnel lens antenna is made of a low-loss dielectric material having a dielectric constant of about 4.7.

18. A device comprising:
a housing including a first end and a second end;
an RF module mounted to the first end of the housing; and
a Fresnel zone plate lens antenna mounted to the second end of the housing, wherein the Fresnel lens receives an RF signal that is collected by the housing and directed to the RF module.

19. The device according to claim 18 wherein the RF module includes a transceiver.

20. The device according to claim 18 wherein the Fresnel lens antenna includes at least two concentric metallized rings that block the RF signal separated by dielectric rings that pass the RF signal, wherein the metallized rings increase in diameter from an interior ring to an exterior ring.
